(19) United States
(12) Patent Application Publication
(10) Pub. No.: US 2022/0115871 A1
(43) Pub. Date: Apr. 14, 2022

(54) Power System Low-Frequency Oscillation Mechanism Identification with CNN and Transfer Learning

(71) Applicants: Zhe Yu, San Jose, CA (US); Yishen Wang, San Jose, CA (US); Xiao Lu, Nanjing (CN); Chunlei Xu, Nanjing (CN); Di Shi, San Jose, CA (US)

(72) Inventors: Zhe Yu, San Jose, CA (US); Yishen Wang, San Jose, CA (US); Xiao Lu, Nanjing (CN); Chunlei Xu, Nanjing (CN); Di Shi, San Jose, CA (US)

(21) Appl. No.: 17/065,627

(22) Filed: Oct. 8, 2020

(51) Int. Cl. H02J 3/24; H02J 13/00; G06N 3/08; G05B 19/042

(52) U.S. Cl. CPC H02J 3/24; H02J 13/00002; G05B 2219/2639; G05B 19/042; G06N 3/08

(57) ABSTRACT

A method is disclosed for identification of the mechanism of power system low-frequency oscillations and distinguish natural oscillations and forced oscillations using machine learning or neural network.

### BACKGROUND

The present invention relates to machine learning of grid power oscillations.

With the growth in size of interconnected power systems and the participation of unsynchronized distributed energy resources, the phenomenon of oscillation has become common and widespread. Insufficient damped oscillations reduce the system margin and increase the risk of instability and cascading failure. Thus, timely and precise control response is crucial.

Oscillations are typically classified as either natural or forced, based on their initial causes. Natural oscillation is caused by a lack of system damping and is triggered by disturbance. Forced oscillation is due to periodic energy injection into the system and can occur even when system damping is sufficient. The most common control strategy for natural oscillations is to adjust the power system stabilizer. The most effective control for forced oscillations is to locate the disturbance source. Thus, distinguishing the two types of oscillations is a prerequisite for the effective damping of oscillations.

Oscillation classifications have been attracting more attention in the past decade. Envelope based approaches have been proposed in which an increase in amplitude is used to distinguish natural oscillations from forced ones. However, the accuracy of the classification depends on the size of the envelope, since the algorithm is found failing when the oscillation is lightly damped. The performance of the spectral method is shown to degrade when the forced oscillation has a frequency close to a system mode frequency. A power spectral density and kurtosis based approach has been used, which is simple and accurate when there is a long time period of data. However, the long-time data requirement limits the method as an off-line application.

Thus, the state of the art in oscillation classification methods typically tends to extract some features of different mechanisms and then summarize them to a given index. This is followed by application of simple (linear) logic rules for the classification of oscillation events. This approach usually is complicated and considerable oscillation event information is lost in the process. Moreover, the rules are typically linear and over-simplified.

### SUMMARY

Machine learning techniques are used to identify oscillation mechanisms that can keep intact as much information as possible of the system while simultaneously addressing the common problem of lack of data in the system.

In one aspect, a framework is used to automatically extract features to distinguish natural and forced oscillations and keep as much information about the system as possible. Second, to overcome the impact of detection of starting points of oscillations, a time augmentation approach is used. Third, a transfer learning approach is applied to transfer models between different systems, which helps to resolve the problem of lack of training data.

In another aspect, a method to distinguish oscillations in a power grid includes:
extracting features to distinguish natural and forced oscillations in a power grid;
detecting ambiguous starting points of oscillations with time augmentation;
constructing angle, speed and voltage time-variant matrices as a color figure with three matrices;
applying the angle, speed and voltage time-variant matrices as inputs to a neural network; and
identifying power system low frequency oscillations and distinguishing between natural oscillations and forced oscillations.

In a further aspect, a power grid includes power generators; one or more power consumers; power grid to transmit power from generators to consumers; and a neural network coupled to the power grid to distinguish oscillations in the power grid. The neural network comprising code for:
extracting features to distinguish natural and forced oscillations in a power grid;
detecting ambiguous starting points of oscillations with time augmentation;
constructing angle, speed and voltage time-variant matrices as a color figure with three matrices;
applying the angle, speed and voltage time-variant matrices as inputs to a neural network; and
identifying power system low frequency oscillations and distinguishing between natural oscillations and forced oscillations.

Advantages of the system may include one or more of the following. The system helps generators and loads interconnected through a network to operated in synchronization at a constant system frequency. If the speed of one generator deviates from the synchronous speed, the power change affects all other generators in the system. When this happens, the system maintains synchronous speed by applying the appropriate control action, such as altering the controllers in the exciter or turbine. The system reduces occurrences of low-frequency oscillation and can also fix the high-speed excitation system (used to prevent the loss of synchronizing torque and to improve transient stability) and avoid the damping characteristics of low-frequency oscillation.

### BRIEF DESCRIPTIONS OF THE FIGURES

The following figures are for illustration purposes only and are not drawn to scale. The exemplary embodiments, both as to organization and method of operation, may best be understood by reference to the detailed description which follows taken in conjunction with the accompanying drawings in which:

FIG. 1 shows an exemplary flow chart of a method to distinguish oscillations in a power grid.

FIG. 2 shows an exemplary structure of a convolutional neural network model.

FIG. 3 illustrates an exemplary operation of the convolutional layer.

FIG. 4 shows an exemplary operation of the pooling layer.

FIG. 5 illustrates an exemplary process to construct the angle, speed and voltage time variant matrix into an RGB figure as the input of the CNN model.

FIG. 6 shows an exemplary data augmentation process which samples a clip of data using a fixed window width and different starting points.

FIG. 7 shows an exemplary process of transfer learning, which keeps the information of one model and transfer it to another system.

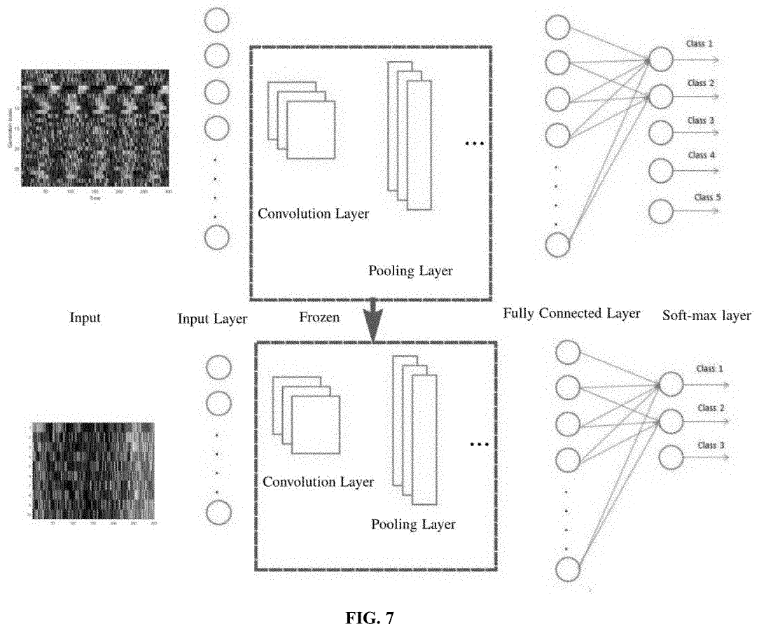

FIG. 8A shows an exemplary hardware test bed.

FIG. 8B shows an exemplary Power Grid and Sensor Network to be managed by the system.

### DETAILED DESCRIPTION OF THE ILLUSTRATED EMBODIMENTS

### Nomenclature

X_{ang}: the data matrix comprised by generator angles.

X_{ang,i}[t]: the generator angle data point at time instant t of generator i.

1 Approaches

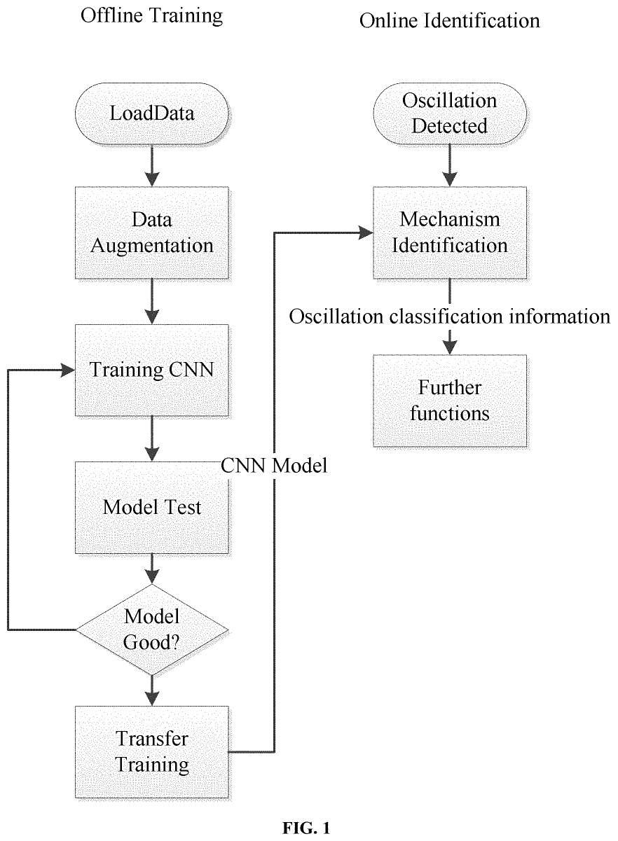

In the preferred embodiment, distinguishing between natural and forced oscillations is formulated as a supervised learning process. In a supervised learning, oscillation data is collected. Features are extracted, and oscillation types are labelled by domain experts. Features and labels are fed to supervised learning algorithms to train a classifier model. The trained classifier can be used online to distinguish oscillation mechanisms. The key points during this process are feature extraction and classifier model selection. Feature extraction is the most important part. Correct extraction needs to reserve all information to train classifier models and remove other noise information. Another requirement of feature extraction is to reduce the volume of data, i.e., the size of feature should be as small as possible. We proposed to use a CNN model to automatically extract the feature. The process of the approach is shown in FIG. 1.

1.1 Convolutional Neural Networks

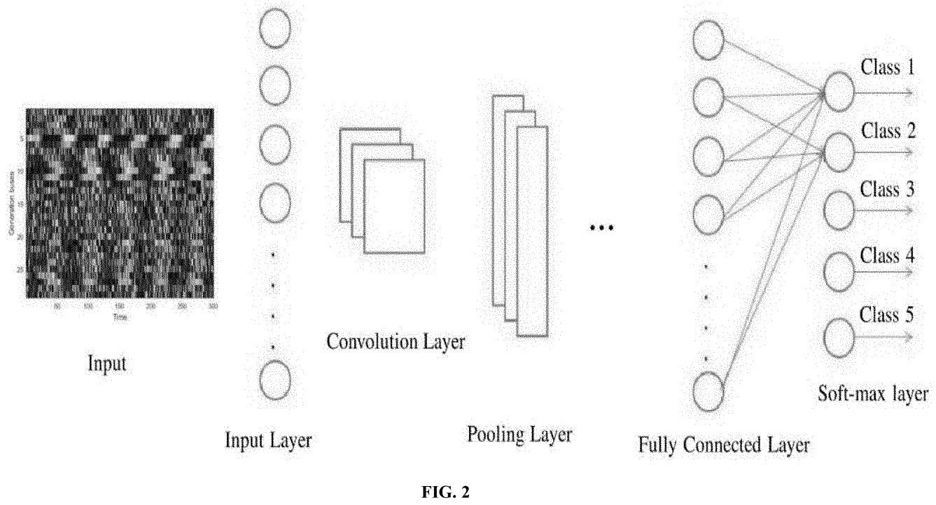

The convolutional neural network (CNN) is shown in FIG. 2. It takes in an image, represented by a sum of multiple matrix, as the input. Usually, there are three matrices indicating three channels of RGB colors, and the image can be viewed as the sum of these three matrices. However, there can be more channels of signals which does not change the fundamental. The signal is passed through an input layer like the one in other neural networks. Then the signal goes through several convolution layers and pooling layers, which is the most important architectures of CNN.

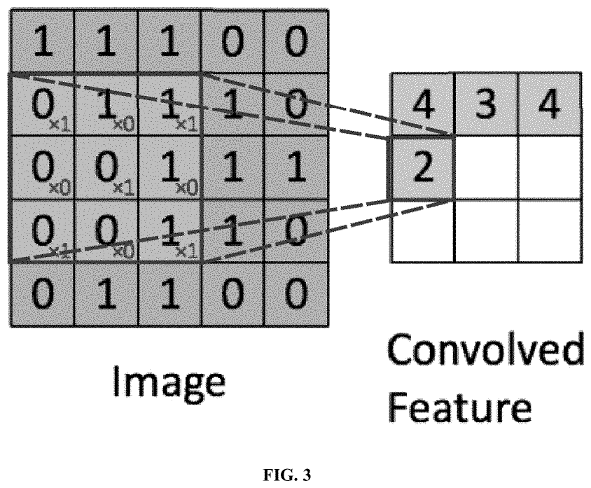

As shown in FIG. 3, a convolution layer defines a mask/filter (the orange one) and convolutes it with each input matrix. This process will result in a feature matrix smaller or equal to the original matrix. The purpose of this process is to extract the feature in the signal. The size and value of this mask is one of the design choices of a CNN model. A default choice would be to choose a mask with an odd number of pixels in each dimension and all 1 elements in it.

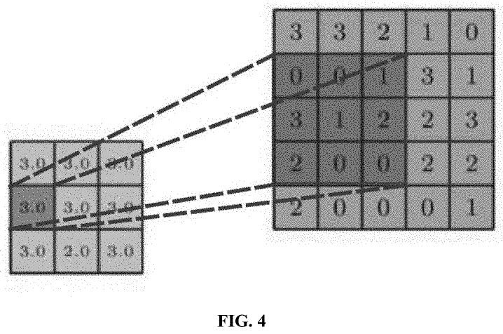

After a convolution layers, a pooling layer is constructed to reduce the dimension. Typical pooling includes maximum pooling and mean pooling. As shown in FIG. 4, the maximum pooling moves a mask through a matrix and calculate the maximum within the mask. This process will reduce the computational cost and denoise the signal.

After several convolution and pooling layers, the result is passed to a fully connected layer and a classification layer which are like the ones in other neural networks.

1.2 Feature Selection

Preferably, we select the nonlinear phase of oscillations as the input, i.e., the beginning period of oscillations. Considering it is hard to detect precisely the beginning point of oscillations, a sliding window with a 5 second width is applied to samples. In this way, multiple clips of samples with different beginning points is generated using one piece of data. Furthermore, each clip of sample is normalized to its z-score, where z[t]=(x[t]−μ(x))/σ(x), μ(x) and σ(x) are the mean and standard deviation of time series X, to eliminate the impact of absolute values.

For CNN model, the feature extraction process is mainly dealt by the convolution process, which makes the procedure easier. Three time variant matrix are constructed using generator angle, voltage, and speed.

$${X}_{ang} • [ \begin{matrix}{X}_{ang , 1} [ 1 ] & {X}_{ang , 1} [ 2 ] & … & {X}_{ang , 1} [ T ] \\ {X}_{ang , 2} [ 1 ] & {X}_{ang , 2} [ 2 ] & … & {X}_{ang , 2} [ T ] \\ ⋯ & & & \\ {X}_{ang , N} [ 1 ] & {X}_{ang , N} [ 2 ] & … & {X}_{ang , N} [ T ]\end{matrix} ] \qquad ( \text{1-1} )$$

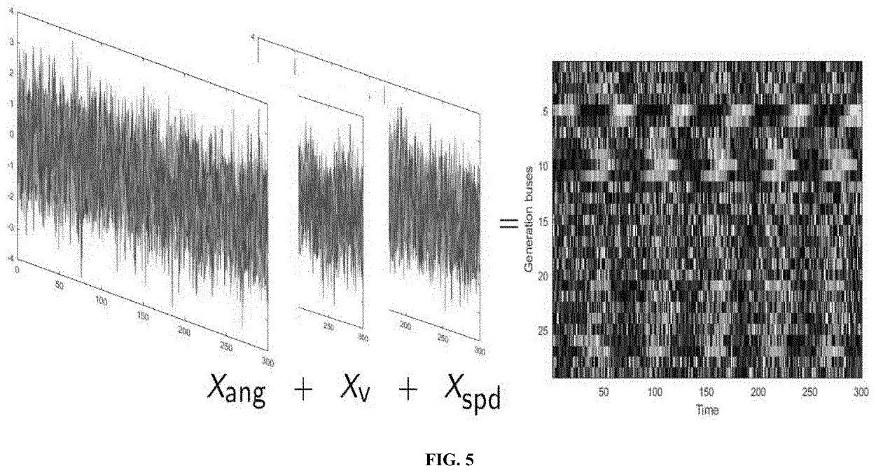

In Equation (1-1), a matrix of generator angle is constructed, where N is the number generators and T is the number of time instances. The same process is carried out for generator voltage and speed. The construction process can be found in FIG. 5.

1.3 Data Augmentation

In real-time application, the detection of the beginning of oscillations are not accurate. A data augmentation method is used to overcome this problem. For each clip of training data, ten samples are generated by sliding a window with width of 5 second and step size of 0.2 second, i.e. the 10th sample is 1.8 seconds later than the first one. To generate a clip of test data, a starting point uniformly distributed among [0,2] is first generate. Then a clip of data with the randomly generated starting point and window width 5 second is sampled from the simulation data. The process of data augmentation can be found in FIG.

1.4 Transfer Learning

Transfer of learning techniques across different test systems and real-world data to validate the performance is done next. Learning transfer takes a pre-trained neural network and use samples from other systems or scenarios to retrain (part of) the network and complete other tasks.

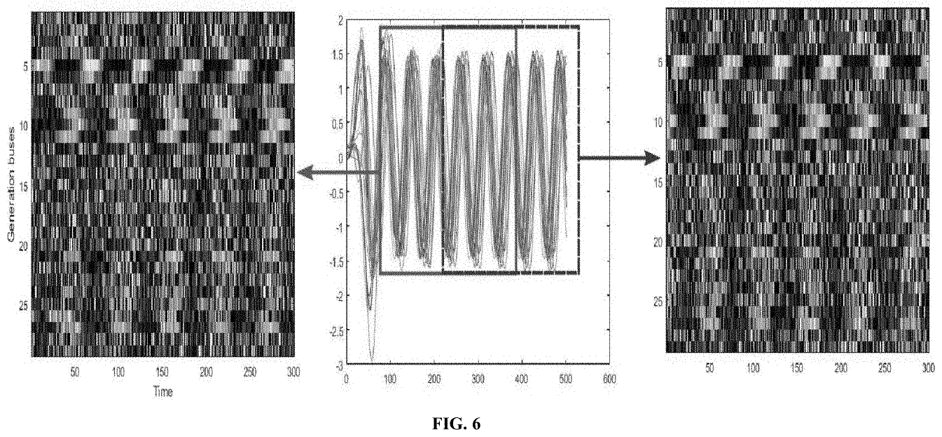

In FIG. 6, an example of the transfer learning is shown. One CNN model is trained using data from the WECC 179-bus system. The pre-trained convolutional layers and pooling layers are taken out to test in a 2-Area-4-Machine system. An input layer, a fully connected layer, and a classification layer are added to the front and back of the pre-trained networks to adjust the input and output dimensions properly. Then a small number of samples from the WECC 179-bus system are fed to the newly constructed network to retrain. During the retrain process, the inherited part of the network is kept frozen, and the number of samples are far less than usual. In this way, the information of the WECC 179-bus system is utilized and helps to develop a model that performs well in the 2-Area-4-Machine system.

2 Case Study

To generate some training data, the Kundur 2-Area-4-Machine (2A4M) and WECC 179-Bus (179Bus) test systems are simulated using Transient Security Assessment Tool (TSAT). To clarify, the samples does not need to be generated in these two systems, in this way, or even using synthetic model. Here, we just want to give an example. For nature oscillation cases, the damping factor of each generator is set to a random value uniformly distributed among [0,4]. Further, loads at each bus are multiplied by factors uniformly distributed among [0.9,1.1] to mimic the randomness in operation conditions. A three-phase fault is added to a random bus and cleared 0.5 second after to trigger oscillations. Other parameters are kept unchanged.

For forced oscillation cases, a sinusoid with a frequency of 0.86 Hz is added to the exciter of a randomly picked generator, and the damping factor of the chosen generator is set to 0 to mimic the injected oscillation source. Loads at each bus are multiplied by factors uniformly distributed among [0.9,1.1]. Other parameters are kept unchanged.

Four hundred nature oscillations and four hundred forced oscillations are generated for 2A4M system, and nine hundred nature oscillations and fourteen hundred forced oscillations are generated for 179Bus systems. After the generation of raw data, a Gaussian distributed factor is multiplied to each measurement to simulate the measurement noise.

2.1 Classification Results without transfer learning

Monte Carlo simulations are carried out to validate the performance of different approaches. In each Monte Carlo run, the labeled data is separated to training set and testing set randomly with a ratio 0.8/0.2.

Various models are trained using the training set and test on the test set. A kurtosis-based method is adopted as a benchmark, which adopt a threshold of kurtosis of data to distinguish oscillation classes. The threshold of kurtosis is set to −0.5. The accuracy is averaged over all Monte Carlo simulations and shown in Table 2-1. All machine learning models perform well, which indicates the efficiency of the features in identification of the oscillation types. However, the kurtosis method performs not desired due to the short period of data and the failure to capture the beginning point of oscillations.

TABLE 2-1
Average accuracy of models over test set

| System | Decision Tree | SVM | FNN | CNN | Kurtosis |
|---|---|---|---|---|---|
| 2A4M | 99.97% | 99.97% | 99.97% | 99.97% | 99.97% |
| 179Bus | 99.60% | 99.60% | 99.60% | 99.60% | 99.60% |

2.2 Classification Results with Transfer Learning

In this subsection, the CNN model is first trained using all labeled data from one system, retrained using 1% data, and tested using the rest data from the second system. Since the input dimension is different for two simulation systems. Thus, the input layers need to be replaced and retrained, and the retrained CNN model can not be applied directly back to the original training system. During the retraining process, the learning rate of the inherited network is set to 0.001 and the maximum number of epochs is set to 5 so that the inherited network is frozen. The learning rate of other parts are set 20 times larger.

TABLE 2-2
Accuracy of transfer learning of CNN models

| Training System | Retraining System | Accuracy |
|---|---|---|
| 2A4M | 179Bus | 99.87% |
| 179Bus | 2A4M | 98.57% |

The result of the CNN models is summarized in Table 2-2. The high accuracy demonstrates the outstanding performance of retrained CNN models.

### 3 Test Bed

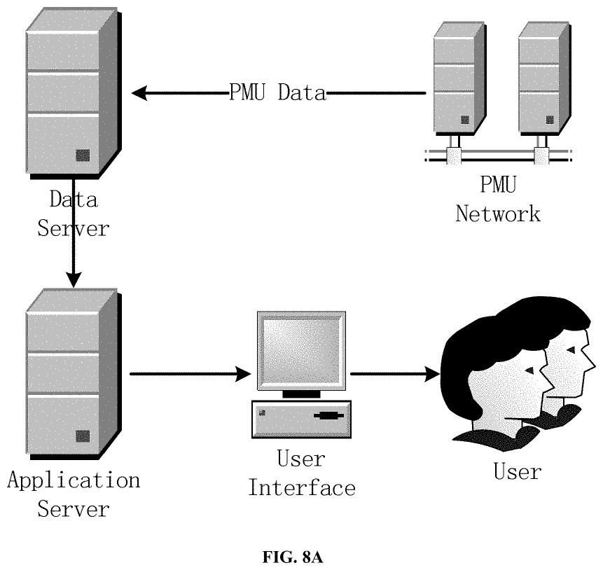

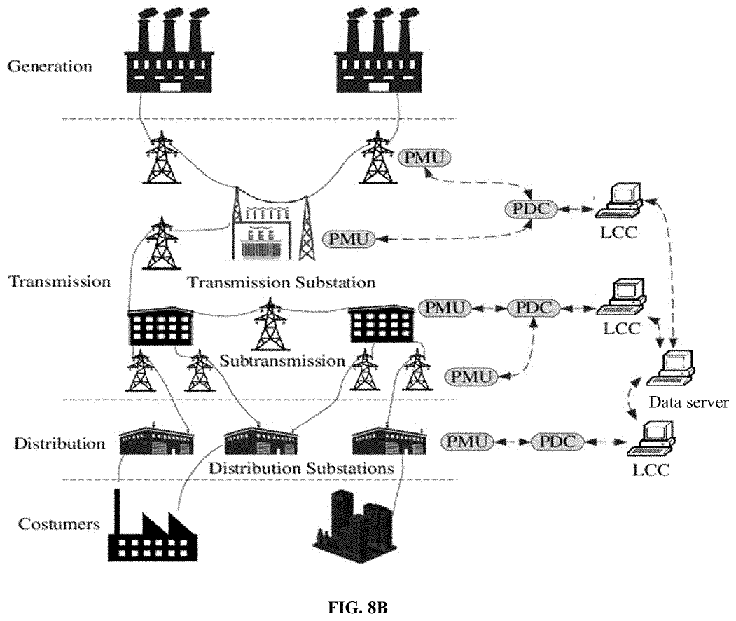

An example of test bed can be found in FIG. A. The test bed models the exemplary Power Grid and Sensor Network of FIG. 8B. Data collected from phasor measurement unit (PMU) is transmitted through PMU networks to the data server. The data server stores and manages the PMU data and provides data pipeline to the application server. The pre-trained CNN model is running on the application server. The classification result is sent to the user interface and shown to the users. The test bed of FIG. 8A modeling the system of FIG. 8B has a framework to automatically extract features to distinguish natural and forced oscillations and keep as much information about the system as possible. Second, to overcome the impact of detection of starting points of oscillations, a time augmentation approach is used. Third, a transfer learning approach is applied to transfer models between different systems, which helps to resolve the problem of lack of training data. The method to distinguish oscillations in a power grid of FIG. 8B includes:
extracting features to distinguish natural and forced oscillations in a power grid;
detecting ambiguous starting points of oscillations with time augmentation;
constructing angle, speed and voltage time-variant matrices as a color figure with three matrices;
applying the angle, speed and voltage time-variant matrices as inputs to a neural network; and
identifying power system low frequency oscillations and distinguishing between natural oscillations and forced oscillations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. As used herein, the term “module” or “component” may refer to software objects or routines that execute on the computing system. The different components, modules, engines, and services described herein may be implemented as objects or processes that execute on the computing system (e.g., as separate threads). While the system and methods described herein may be preferably implemented in software, implementations in hardware or a combination of software and hardware are also possible and contemplated. In this description, a “computing entity” may be any computing system as previously defined herein, or any module or combination of modulates running on a computing system. All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method to distinguish oscillations in a power grid, comprising:
extracting features to distinguish natural and forced oscillations in a power grid;
compensating for ambiguous starting points of oscillations with time augmentation;
constructing angle, speed and voltage time-variant matrices as a color figure with three matrices;
applying the angle, speed and voltage time-variant matrices as inputs to a neural network; and
identifying power system low-frequency oscillations and distinguishing between natural oscillations and forced oscillations.

2. The method of claim 1, comprising performing off-line training of the neural network.

3. The method of claim 1, comprising:
generating labels for oscillation types using a domain expert;
performing supervised learning to train the neural network, wherein after training the neural network is used to distinguish oscillation phenomena.

4. The method of claim 1, wherein the neural network comprises a convolutional neural network (CNN).

5. The method of claim 1, comprising selecting nonlinear phase of oscillations as input to the neural network.

6. The method of claim 5, comprising applying a sliding window with a 5 second width to samples to provide multiple samples with different beginning points.

7. The method of claim 5, comprising determining a z-score, where z[t]=(x[t]−μ(x))/σ(x), μ(x) and σ(x) are the mean and standard deviation of time series X.

8. The method of claim 1, comprising generating a variant matrix.

9. The method of claim 8, comprising constructing three time-variant matrices using generator angle, voltage, and speed.

10. The method of claim 9, comprising determining a matrix of generator angle:
$${X}_{ang} • [ \begin{matrix}{X}_{ang , 1} [ 1 ] & {X}_{ang , 1} [ 2 ] & … & {X}_{ang , 1} [ T ] \\ {X}_{ang , 2} [ 1 ] & {X}_{ang , 2} [ 2 ] & … & {X}_{ang , 2} [ T ] \\ ⋯ & & & \\ {X}_{ang , N} [ 1 ] & {X}_{ang , N} [ 2 ] & … & {X}_{ang , N} [ T ]\end{matrix} ]$$
where N is the number generators and T is the number of time instances.

11. The method of claim 1, comprising applying data augmentation to compensating for ambiguous starting points of oscillations events.

12. The method of claim 1, comprising performing transfer learning to transfer models between different power systems to address lack of training data.

13. The method of claim 12, comprising adding an input layer, a fully connected layer, and a classification layer to the front and back of the neural network to adjust input and output dimensions and feeding predetermined samples from a power grid to a second network to retrain and during retraining an inherited part of the second network is frozen.

14. A method to manage grid power, comprising:
providing a framework to automatically extract features to distinguish natural and forced oscillations;
detecting ambiguous starting points of oscillations with time augmentation;
constructing angle, speed and voltage time-variant matrices as a color figure with three matrices and providing the three matrices to a convolutional neural network (CNN).
performing transfer learning to transfer models between different systems, which helps to resolve the problem of lack of training data.

15. The method of claim 14, comprising determining a z-score, where z[t]=(x[t]−μ(x))/σ(x), μ(x) and σ(x) are the mean and standard deviation of time series X.

16. The method of claim 14, comprising determining a matrix of generator angle:
$${X}_{ang} • [ \begin{matrix}{X}_{ang , 1} [ 1 ] & {X}_{ang , 1} [ 2 ] & … & {X}_{ang , 1} [ T ] \\ {X}_{ang , 2} [ 1 ] & {X}_{ang , 2} [ 2 ] & … & {X}_{ang , 2} [ T ] \\ ⋯ & & & \\ {X}_{ang , N} [ 1 ] & {X}_{ang , N} [ 2 ] & … & {X}_{ang , N} [ T ]\end{matrix} ]$$
where N is the number generators and T is the number of time instances.

17. The method of claim 12, comprising adding an input layer, a fully connected layer, and a classification layer to the front and back of the neural network to adjust input and output dimensions and feeding predetermined samples from a power grid to a second network to retrain and during retraining an inherited part of the second network is frozen.

18. A power grid, comprising:
a power generator;
one or more power consumers; and
a neural network coupled to the power grid to distinguish oscillations in the power grid, the neural network comprising code for:
extracting features to distinguish natural and forced oscillations in a power grid;
compensating for ambiguous starting points of oscillations with time augmentation;
constructing angle, speed and voltage time-variant matrices as a color figure with three matrices;
applying the angle, speed and voltage time-variant matrices as inputs to a neural network; and
identifying power system low frequency oscillations and distinguishing between natural oscillations and forced oscillations.

19. The grid of claim 18, comprising code for determining a z-score, where z[t]=(x[t]−μ(x))/σ(x), μ(x) and σ(x) are the mean and standard deviation of time series X.

20. The grid of claim 18, comprising determining a matrix of generator angle:
$${X}_{ang} • [ \begin{matrix}{X}_{ang , 1} [ 1 ] & {X}_{ang , 1} [ 2 ] & … & {X}_{ang , 1} [ T ] \\ {X}_{ang , 2} [ 1 ] & {X}_{ang , 2} [ 2 ] & … & {X}_{ang , 2} [ T ] \\ ⋯ & & & \\ {X}_{ang , N} [ 1 ] & {X}_{ang , N} [ 2 ] & … & {X}_{ang , N} [ T ]\end{matrix} ]$$
where N is the number generators and T is the number of time instances.
